(19) United States
(12) Patent Application Publication
(10) Pub. No.: US 2005/0028211 A1
(43) Pub. Date: Feb. 3, 2005

(54) Transmitter and transmission method

(75) Inventors: Toshikazu Mochizuki, Hamura-shi (JP); Mitsuyuki Nozaki, Tokyo (JP); Mitsutaka Kuwabara, Fukaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/871,377

(22) Filed: Jun. 21, 2004

(30) Foreign Application Priority Data
Jul. 31, 2003 (JP) 2003-311972

(51) Int. Cl. H04J 3/16; H04J 3/22

(52) U.S. Cl. 725/80; 725/153

(57) ABSTRACT

A digital data output circuit generates video and audio data. An HDMI LSI generates transmission video and audio data by alternately arranging the video data and audio data generated from the digital data output circuit. An LSI control portion outputs a data switching signal which is used to switch the transmission video and audio data. Further, the HDMI LSI selects and transmits one or both of the generated video and audio data in accordance with the data switching signal from the LSI control portion.

### CROSS-REFERENCE TO RELATED APPLICATIONS

This application is based upon and claims the benefit of priority from prior Japanese Patent Application No. 2003-311972, filed Jul. 31, 2003, the entire contents of which are incorporated herein by reference.

### BACKGROUND OF THE INVENTION

1. Field of the Invention

The present invention relates to a technique to select transmission data and transmit it in an HDMI (High-Definition Multimedia Interface) used to transmit video and audio signals.

2. Description of the Related Art

A technique to transmit video and audio signals is disclosed in, e.g., Jpn. Pat. Appln. KOKAI Publication No. 2001-266489. In recent years, HDMI has been standardized as a method to transmit high-definition video and audio signals. The HDMI is a digital video/audio interface compatible with HDTVs, and its final specification was released in February, 2003.

According to the specification, a transmitter alternately transmits video and audio data to a receiver by using the same wiring. In this interface, a transmitter which can output both video/audio data, such as TVs, can be connected with a receiver through one cable, which is convenient. However, there may occur a deterioration in data quality, such as so-called data distortion, in which a value of data varies due to mutual interference of data or noise.

When such a deterioration occurs, defects such as non-output of video, discontinuation or disorder of video, non-output or discontinuation of audio, audio or video mixed with noise, and the like occur.

### BRIEF SUMMARY OF THE INVENTION

According to the present invention, there is provided a transmitter which selectively transmits video and audio signals, comprising: a signal generation portion which generates video and audio signals; an arrangement portion which generates video data and audio data in which the video data and the audio data are alternately arranged based on the video and audio signals generated from the signal generation portion; an output control portion which outputs a data switching signal used to individually turn on/off transmission of the video data and the audio data generated by the arrangement portion in accordance with a receiver connected with the transmitter; and a transmission control portion which transmits one or both of the video data and the audio data to the receiver by controlling transmission of the video data and the audio data based on the data switching signal outputted by the output control portion.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a structure in which a transmitter and a receiver are connected with each other in a one-on-one relationship;

FIG. 2 is a view showing another structure in which the transmitter and the receiver are connected with each other in a one-on-one relationship;

FIG. 3 is a view showing a structure in which the transmitter and the receivers are connected with each other in a relationship of one-on-two or more;

FIGS. 4A and 4B are views showing other structures in which the transmitter and the receivers are connected with each other in a one-on-two or above relationship;

FIG. 5 is a view showing a structure when connecting to an HDTV and a video device or an audio device;

FIG. 6 is a block diagram showing an STB as a transmitter 1;

FIG. 7 is a block diagram showing a structure of a primary portion of an HDMI transmitter 1;

FIG. 8 is a view showing a basic specification of the HDMI as a reference;

FIG. 9 is a view illustrating signals generated by a control circuit 6 and a digital data output circuit 7;

FIG. 10 is a flowchart showing an operation of the control circuit 6;

FIG. 11 is a flowchart showing an operation of an HDMI LSI 5; and

FIGS. 12A to 12C are signal diagrams showing switching of HDMI transmission data.

### DETAILED DESCRIPTION OF THE INVENTION

An embodiment according to the present invention will now be described hereinafter in detail with reference to the accompanying drawings.

As a structure to switch data transmitted from an HDMI of a transmitter and selectively output one of video data and audio data to a receiver, such structures as shown in FIGS. 1 to 6 can be considered. In these drawings, a transmitter 1 is a device such as a set-top box (STB) or a DVD reproduction apparatus, which can transmit video and audio data as HDMI data. Further, receivers such as a video device 3 or an audio device 4 are all HDMI-compatible devices.

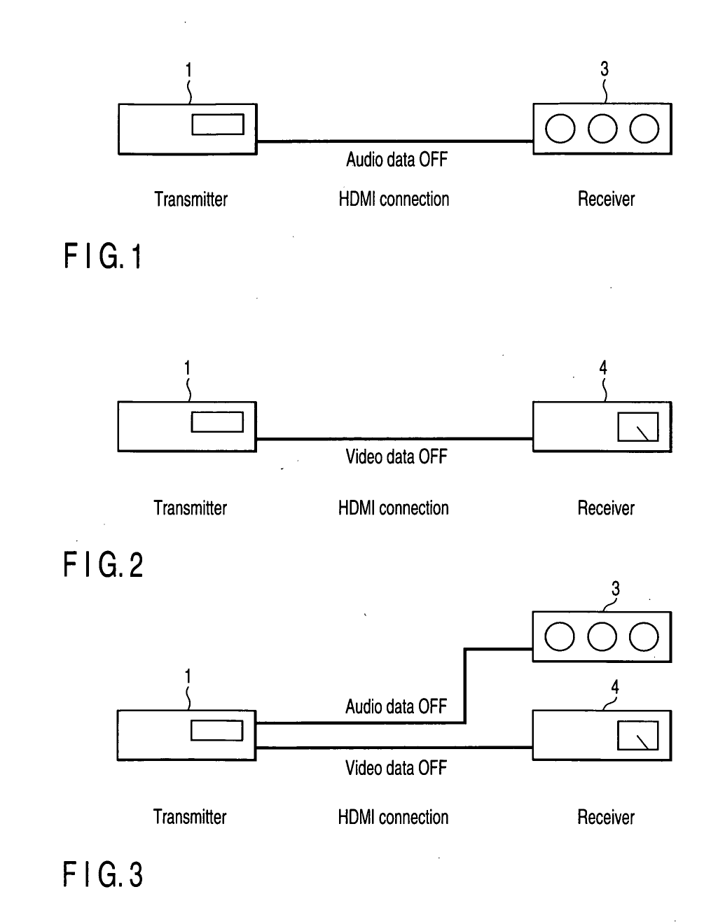

FIGS. 1 and 2 show structures in which a transmitter and a receiver are connected with each other in a one-on-one relationship. If the receiver in FIG. 1 is a video device 3 such as a projector, only video data is transmitted to the receiver by turning off output of audio data on the transmitter 1 side. If the receiver in FIG. 2 is an audio device 4 such as an AV amplifier, only audio data is transmitted to the receiver by turning off output of video data on the transmitter 1 side.

FIGS. 3 to 5 show structures in which the transmitter and the receivers are connected with each other in a relationship of one-on-two or more. If the receivers in FIG. 3 are of different types, e.g., a video device 3 and an audio device 4, only video data is transmitted to the video device 3 by turning off output of audio data and only audio data is transmitted to the audio device 4 by turning off output of video data, respectively.

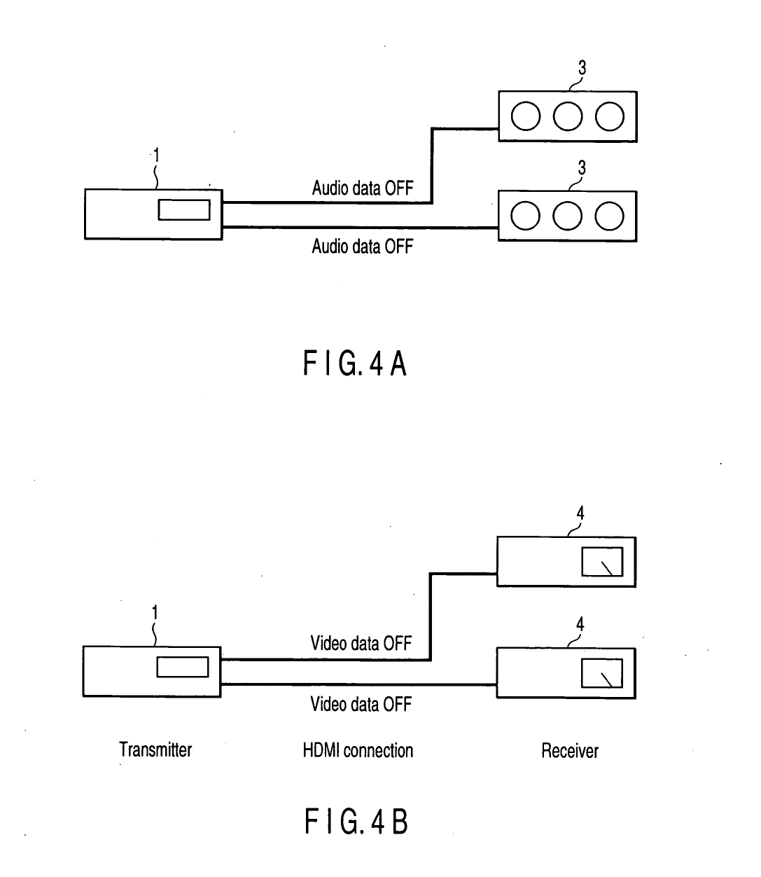

FIGS. 4A and 4B show connections when the both receivers are the video devices 3 or the audio devices. If the both receivers are the video devices 3 as shown in FIG. 4A, only video data is transmitted by turning off output of audio data. If the both receivers are the audio devices 4 as shown in FIG. 4B, only audio data is transmitted by turning off output of video data.

FIG. 5 shows a connection structure between an HDTV and a video device or an audio device. Regular HDMI data is transmitted to an HDTV 2, only video data is transmitted when one receiver is the video device 3, and only audio data is transmitted when one receiver is the audio device 4.

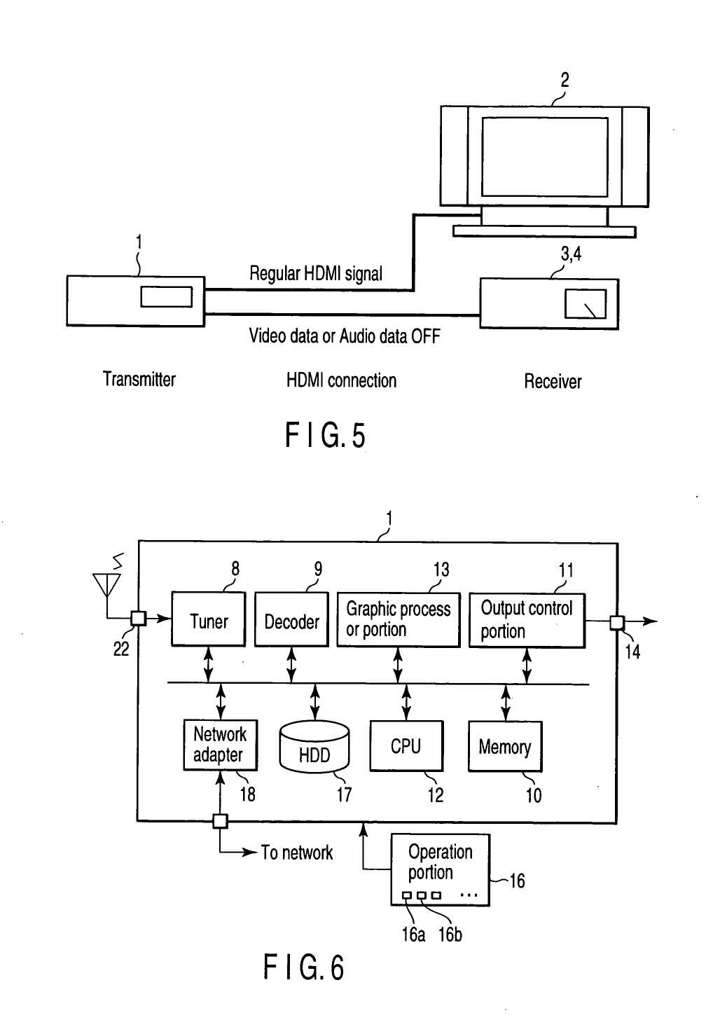

FIG. 6 shows an example of a basic structure to realize the transmitter 1 according to the present invention.

FIG. 6 is a block diagram showing an STB 1 as the transmitter 1 to which the present invention is applied. The STB 1 is, e.g., a digital satellite broadcast receiver. This STB 1 comprises an input portion 22, a tuner 8, a decoder 9, a memory 10, an output control portion 11, a CPU 12, a graphic processing portion 13, an output terminal 14, an operation portion 16, an HDD 17, and a network adapter 18 which realizes an interface to a communication network.

A broadcast signal received by an antenna is inputted to the input portion 22. Specific program data is extracted by the tuner 8 from the broadcast signal inputted through the input portion 22, and the extracted program data is decoded by the decoder 9. The output control portion 11 converts audio and video data of the program decoded by the decoder 9 into HDMI data, and transmits it through the output terminal 14.

The graphic processing portion 13 generates, e.g., OSD (on screen display) images according to needs. The memory 10 includes a ROM which stores a program according to the present invention and a RAM used as a work area for the CPU 12. The operation portion 16 is, e.g., a remote controller, and various keys 16a and 16b used to accept various kinds of input operations are provided to this operation portion 16.

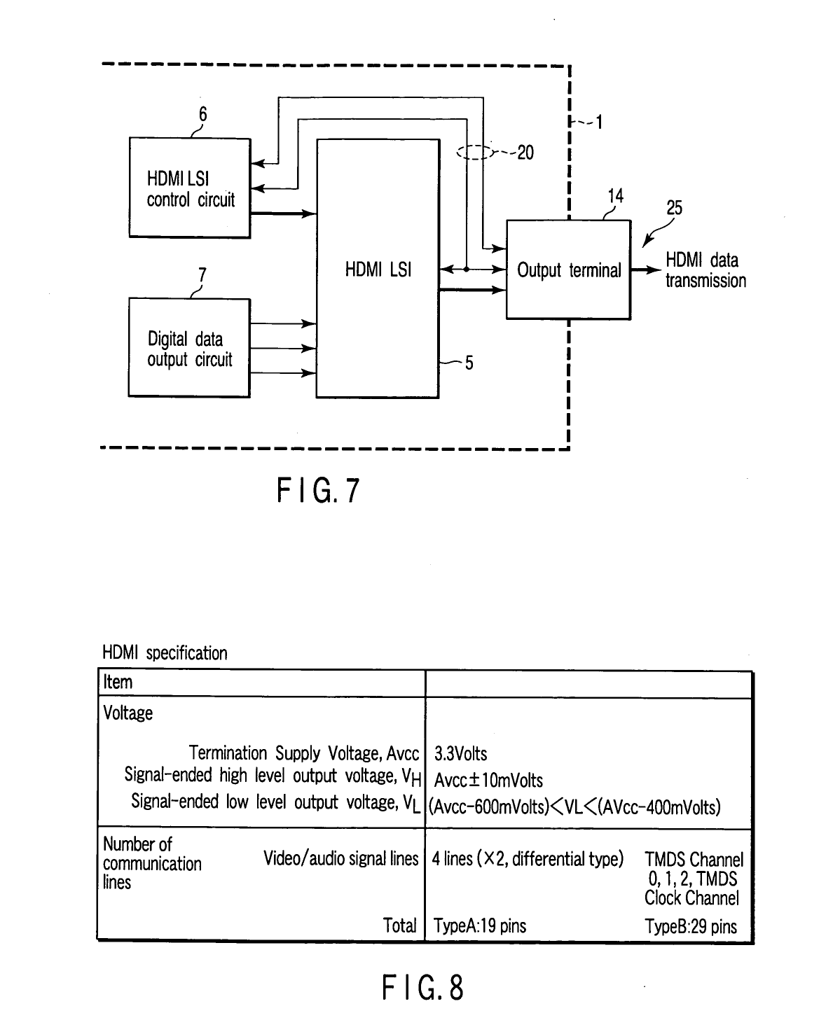

FIG. 7 is a block diagram showing a structure of a primary part of the HDMI transmitter 1. The transmitter 1 includes an HDMI LSI 5 which creates HDMI output data, a control circuit 6 which controls the HDMI LSI 5, a digital data output circuit 7 which generates digital audio data and digital video data, the basic components of HDMI data, and an output terminal 14 used to transmit processed data to the outside. Note that the HDMI LSI 5 and the control circuit 6 correspond to the output control portion 11 of the STB 1 depicted in FIG. 6, and the output circuit 7 corresponds to the tuner 8 and the decoder 9.

FIG. 8 is a view showing a basic specification of the HDMI for reference. In the HDMI, audio and video data are transmitted as serial data based on such a specification. The HDMI LSI 5 generates serial data in which the video data and the audio data are alternately arranged based on video and audio signals produced from the output circuit 7.

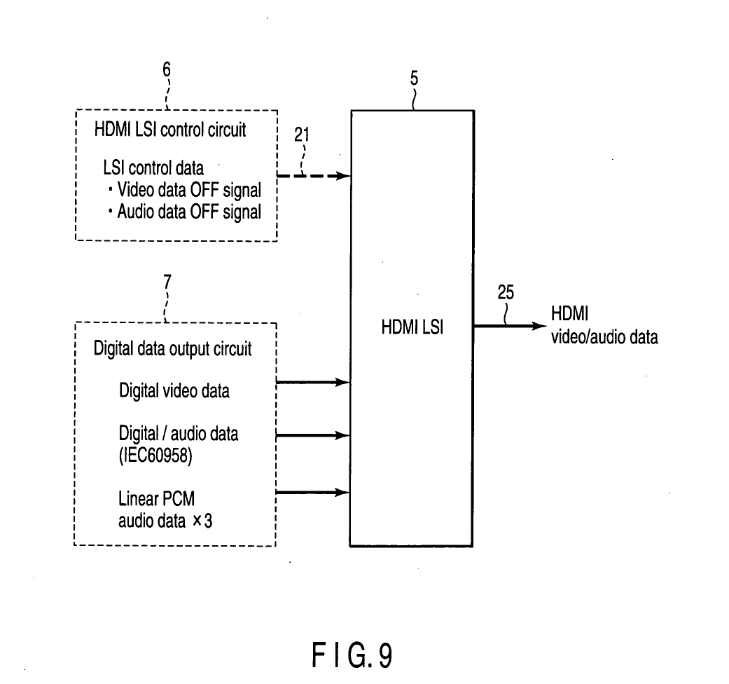

FIG. 9 is a view illustrating signals generated by the control circuit 6 and the digital data output circuit 7. Output data of the HDMI LSI is switched by adding a signal to turn off output of the video data and a signal to turn off the audio data to control data outputted from the control circuit 6 of the HDMI LSI to a signal line 21.

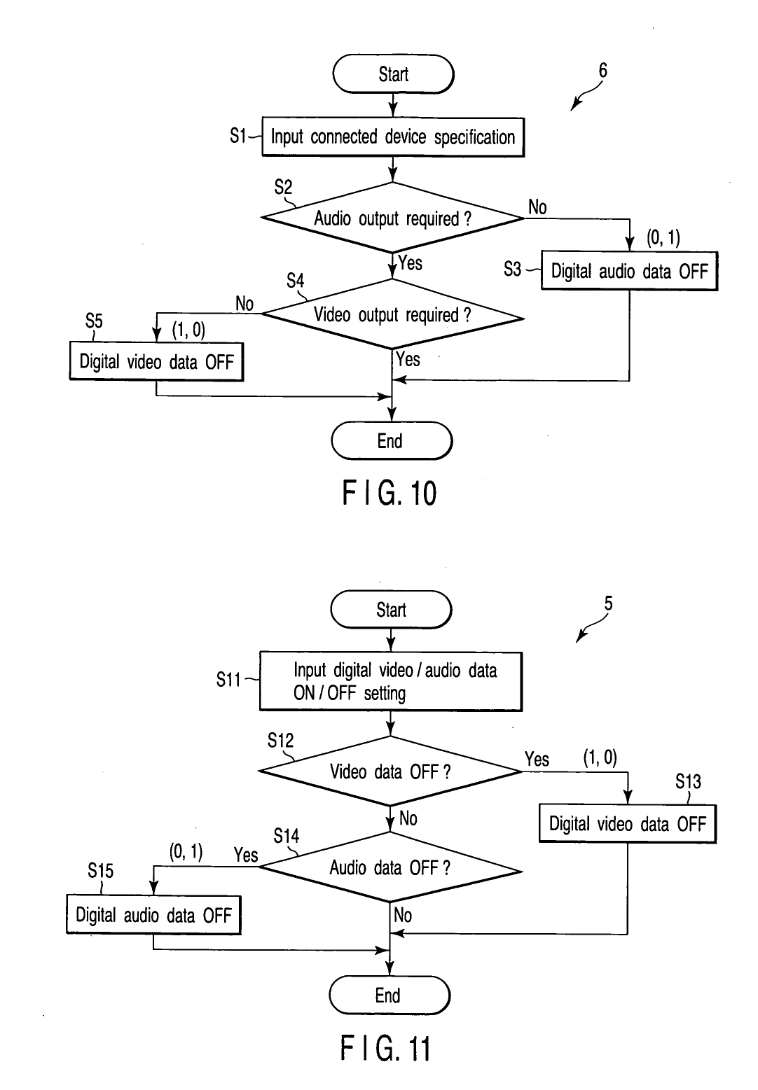

FIG. 10 is a flowchart illustrating an operation of the control circuit 6.

First, the control circuit 6 inputs a specification of the connected device as described in a step S1. “Specification” means information indicative of the type of receiver, and information indicating whether the receiver is a video device 3 such as a projector, an audio device 4 such as an AV amplifier, or an AV device 2 such as a digital television. This information is input through an HDMI cable 25, which connects the output terminal 14 with the receiver and a signal line 20, as device information of the receiver, and is provided as EDID (Extended Display Identification Data) from the receiver, or a user instruction provided from the operation portion 16.

Based on the specification of the connected device, the control circuit 6 determines whether audio output is required, as illustrated at a step S2. If the receiver, like the video device 3, does not require the audio output (in the case of no), a digital audio data OFF signal (e.g., “0, 1”) is outputted to the signal line 21 as ON/OFF setting information of digital video/audio data. Then, the control circuit 6 determines whether the video output is required, as illustrated at a step S4. If the receiver, like the audio device 4, does not require the video output (in case of no), a digital video data OFF signal (e.g., “1, 0”) is outputted to the signal line 21 as ON/OFF setting information. In the case of yes at the step S4, the control circuit 6 terminates this processing without outputting an OFF signal. The signal line 21 is pulled up to a power supply, and a signal “1, 1” is outputted to the signal line 21 when the control circuit 6 does not output the OFF signal.

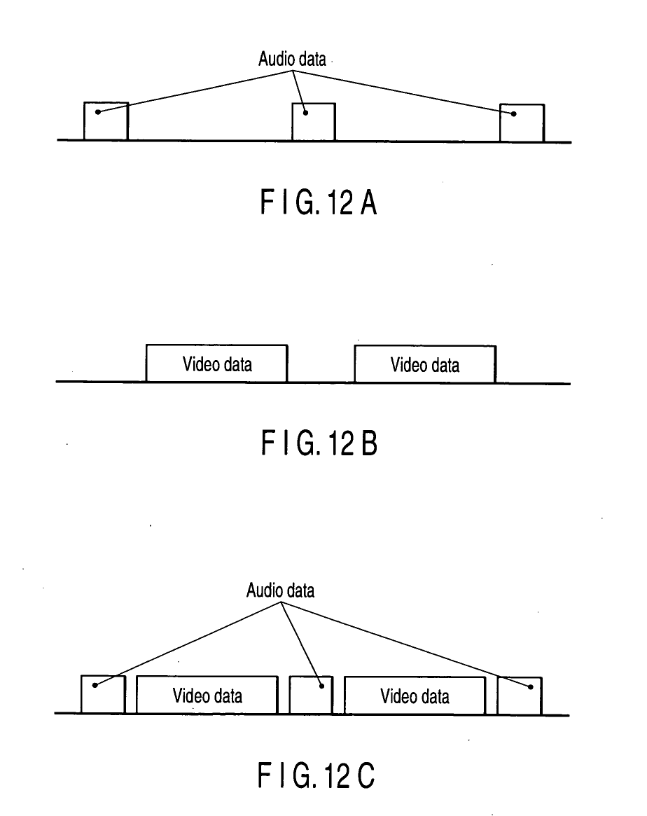

When the HDMI LSI 5 receives the video/audio data OFF signal from this control circuit 6, it switches HDMI transmission data. FIG. 11 is a flowchart showing an operation of the HDMI LSI 5, and FIGS. 12A to 12C are a signal diagrams showing switching of the HDMI transmission data.

First, the HDMI LSI 5 receives the digital video/audio data ON/OFF setting information from the control circuit 6 as illustrated at a step S11. In the case of the video data OFF (setting information is “1, 0”) as illustrated at a step S12, the control circuit 6 turns off the digital video data (S13). FIG. 12A shows the HDMI transmission data at the time of the video data OFF. Erroneous reading of data due to an affect of the video data can be avoided by sufficiently assuring an interval between respective sets of audio data.

Then, in the case of the audio data OFF (setting information is “0, 1”) as illustrated at a step S14, the control circuit 6 turns off the digital audio data (S15). FIG. 12B shows the HDMI transmission data in this case. There is no audio data, and erroneous reading of data due to an affect of the audio data can be avoided by sufficiently assuring an interval between respective sets of video data.

Note that FIG. 12C shows regular HDMI transmission data. The video data and the audio data are alternately transmitted and they interfere with each other. Therefore, the respective sets of data may be adversely affected.

As described above, according to the present invention, it is possible to realize data transmission with less erroneous reading of the receiver and provide high-definition and high-quality digital data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A transmitter which selectively transmits video and audio signals, comprising:
a signal generation portion which generates video and audio signals;
an arrangement portion which generates video data and audio data in which the video data and the audio data are alternately arranged based on the video and audio signals generated from the signal generation portion;
an output control portion which outputs a data switching signal used to individually turn on/off transmission of the video data and the audio data generated by the arrangement portion in accordance with a receiver connected with the transmitter; and
a transmission control portion which transmits one or both of the video data and the audio data to the receiver by controlling transmission of the video data and the audio data based on the data switching signal outputted by the output control portion.

2. The transmitter according to claim 1, wherein the arrangement portion converts the video and audio signals from the signal generation portion into HDMI (High-Definition Multimedia Interface) data.

3. The transmitter according to claim 1, wherein the output control portion determines the type of receiver based on EDID (Extended Display Identification Data) from the receiver connected with the transmitter, and generates the switching signal in accordance with the determined type.

4. The transmitter according to claim 2, wherein the output control portion determines the type of receiver based on EDID (Extended Display Identification Data) from the receiver connected with the transmitter, and generates the switching signal in accordance with the determined type.

5. The transmitter according to claim 1, further comprising a user interface used to input a user instruction, wherein the output control portion generates the switching signal based on the user instruction obtained from the user interface.

6. The transmitter according to claim 2, further comprising a user interface used to input a user instruction, wherein the output control portion generates the switching signal based on the user instruction obtained from the user interface.

7. A transmission method in a transmitter which transmits video and audio signals, comprising:
generating video and audio signals;
generating a data switching signal which is used to switch data transmitted from the transmitter;
generating video data and audio data in which the video signal and the audio signal are alternately arranged based on the generated video and audio signals; and
selecting and transmitting one or both of the video data and the audio data in accordance with the data switching signal.

8. The transmission method according to claim 7, wherein generation of the arranged video and audio data converts the generated video and audio signals into HDMI (High-Definition Multimedia Interface) data.

9. The transmission method according to claim 8, wherein generation of the switching signal determines the type of receiver connected with the transmitter based on EDID (Extended Display Identification Data) from the receiver, and generates the switching signal in accordance with the determined type.

10. The transmission method according to claim 8, wherein generation of the switching signal generates the switching signal based on a user instruction obtained from a user interface which is used to input the user instruction.
